(19) United States
(12) Patent Application Publication
(10) Pub. No.: US 2006/0135893 A1
(43) Pub. Date: Jun. 22, 2006

(54) Foot massaging device

(76) Inventor: Pei Syun Li, Taichung County (TW)

Correspondence Address: CHARLES E. BAXLEY, ESQ., 90 JOHN STREET, THIRD FLOOR, NEW YORK, NY, 10038, US

(21) Appl. No.: 11/019,872

(22) Filed: Dec. 21, 2004

(51) Int. Cl. A61H 7/00

(52) U.S. Cl. 601/134; 601/28; 601/104

(57) ABSTRACT

A foot massaging device includes two shoe-shaped pedals, and a plurality of massaging members each retractably mounted on each of the two pedals. Thus, the massaging members are retractably pressed on the user's feet to provide a massaging effect, thereby enhancing the massaging effect of the foot massaging device. In addition, each of the massaging members is selectively mounted on a determined position of each of the two pedals to massage a determined position of the user's feet so as to satisfy the user's practical requirements.

### BACKGROUND OF THE INVENTION

1. Field of the Invention

The present invention relates to a foot massaging device, and more particularly to a foot massaging device is operated easily and conveniently.

2. Description of the Related Art

A conventional foot massaging device is pressed on a user's feet to provide a massaging effect to the user's feet. However, the conventional foot massaging device has a complicated construction, thereby increasing costs of fabrication thereof. In addition, the conventional foot massaging device is not assembled easily and rapidly, thereby wasting the manual work and working time. Further, the conventional foot massaging device has a fixed structure and cannot be adjusted to massage a determined position of the user's feet, so that the conventional foot massaging device cannot satisfy the user's practical requirements.

### SUMMARY OF THE INVENTION

The present invention is to mitigate and/or obviate the disadvantage of the conventional foot massaging device.

The primary objective of the present invention is to provide a foot massaging device, wherein the massaging members are retractably pressed on the user's feet to provide a massaging effect, thereby enhancing the massaging effect of the foot massaging device.

Another objective of the present invention is to provide a foot massaging device, wherein each of the massaging members is selectively mounted on a determined position of each of the two pedals to massage a determined position of the user's feet so as to satisfy the user's practical requirements.

A further objective of the present invention is to provide a foot massaging device, wherein the spring of each of the massaging members provides a cushioning effect to the user's feet, thereby providing a comfortable sensation to the user.

In accordance with the present invention, there is provided a foot massaging device, comprising:

two shoe-shaped pedals;

a plurality of massaging members each retractably mounted on each of the two pedals.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a foot massaging device in accordance with the preferred embodiment of the present invention;

FIG. 2 is an exploded perspective view of the foot massaging device as shown in FIG. 1;

FIG. 3 is a partially plan cross-sectional view of the foot massaging device as shown in FIG. 1;

FIG. 4 is a locally enlarged view of the foot massaging device as shown in FIG. 3;

FIG. 5 is a schematic operational view of the foot massaging device as shown in FIG. 3 in use; and

FIG. 6 is a locally enlarged view of the foot massaging device as shown in FIG. 5.

### DETAILED DESCRIPTION OF THE INVENTION

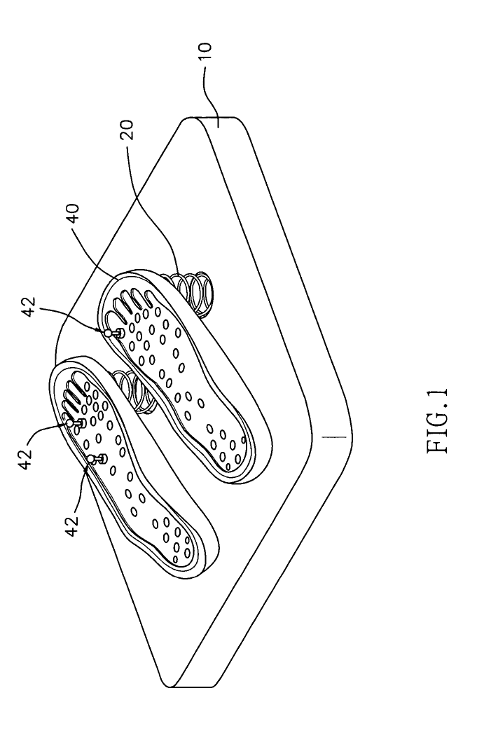

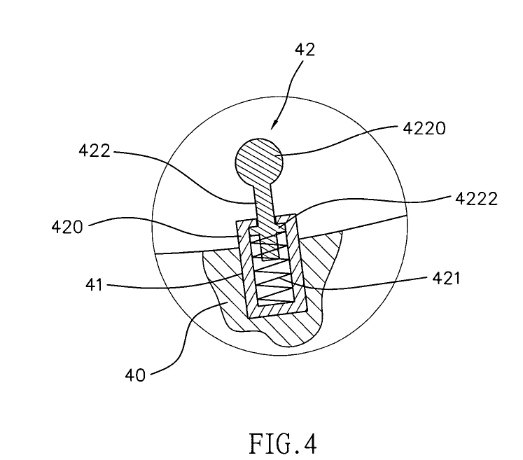

Referring to the drawings and initially to FIGS. 1-4, a foot massaging device in accordance with the preferred embodiment of the present invention comprises a base 10, two shoe-shaped pedals 40 each mounted on the base 10 and each having a first end pivotally mounted on a first end of the base 10, and two biasing members 20 each mounted on the base 10 and each biased between a second end of the base 10 and a second end of a respective one of the two pedals 40.

The base 10 is a rectangular board. The first end of the base 10 is formed with a plurality of stepped screw bores 12 for screwing a plurality of screws 30. The second end of the base 10 is formed with two circular mounting recesses 11.

The first end of each of the two pedals 40 is formed with a plurality of fixing holes 43 for mounting the screws 30. The second end of each of the two pedals 40 has a bottom formed with a circular mounting recess 44.

Each of the two biasing members 20 has a first end mounted in a respective one of the two mounting recesses 11 of the base 10 and a second end mounted in the mounting recess 44 of a respective one of the two pedals 40.

The foot massaging device further comprises a plurality of massaging members 42 each retractably mounted on each of the two pedals 40. Each of the two pedals 40 has an upper surface formed with a plurality of mounting holes 41 to receive the massaging members 42. Each of the massaging members 42 is selectively mounted in a respective one of the mounting holes 41 of each of the two pedals 40.

Each of the massaging members 42 includes a housing 420 mounted in a respective one of the mounting holes 41 of each of the two pedals 40, a movable post 422 movably mounted on the housing 420 and having a first end protruded outward from the housing 420 and formed with a spherical massaging boss 4220 and a second end received in the housing 420 and formed with a resting flange 4222 rested on a top wall of the housing 420, and a spring 421 mounted in the housing 420 and pressed on the second end of the movable post 422. The spring 421 of each of the massaging members 42 has a first end rested on a bottom wall of the housing 420 and a second end rested on the resting flange 4222 of the movable post 422.

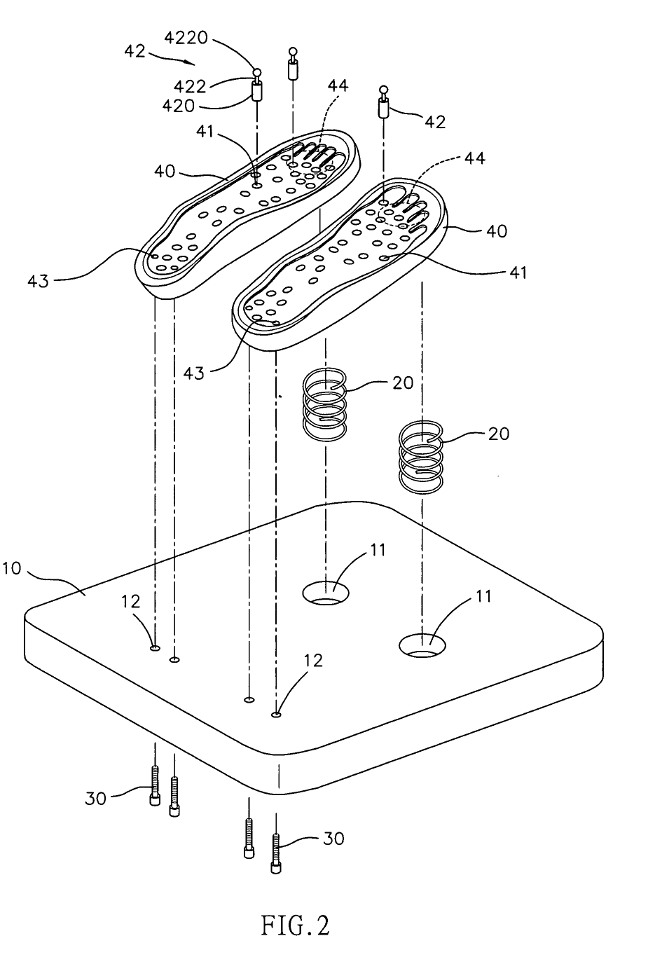

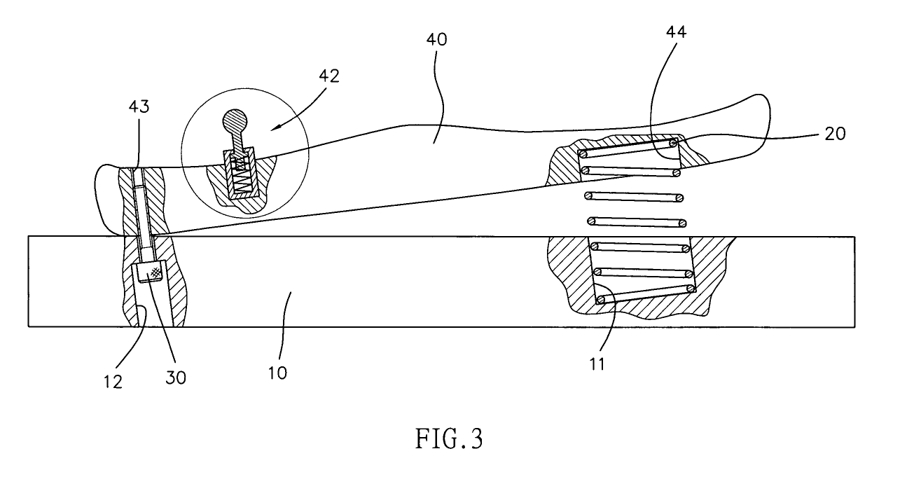

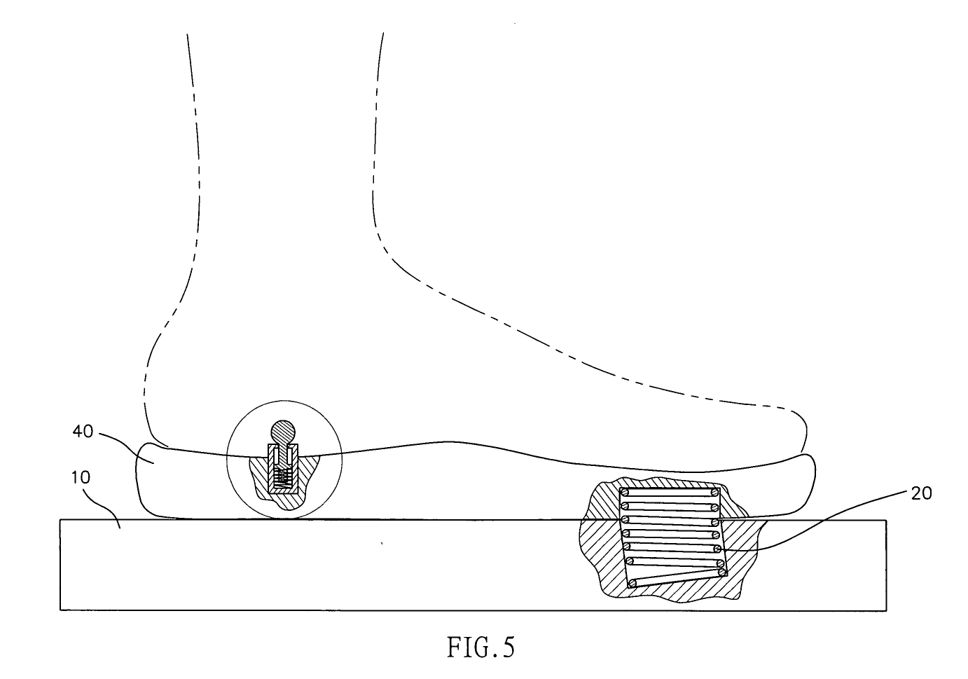

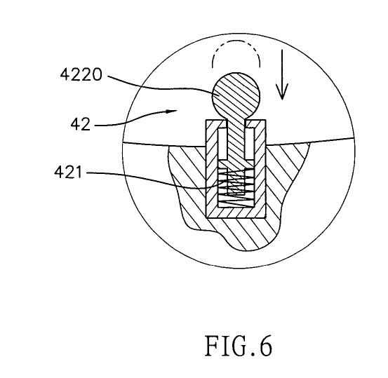

When in use, referring to FIGS. 3-6 with reference to FIGS. 1 and 2, when a user's two feet are stepped on the two pedals 40, the two biasing members 20 are compressed, and the massaging members 42 are compressed by the user's feet. At this time, the massaging bosses 4220 of the massaging 11 members 42 are pressed on the user's feet to provide a massaging effect.

Accordingly, the massaging members 42 are retractably pressed on the user's feet to provide a massaging effect, thereby enhancing the massaging effect of the foot massaging device. In addition, each of the massaging members 42 is selectively mounted on a determined position of each of the two pedals 40 to massage a determined position of the user's feet so as to satisfy the user's practical requirements. Further, the spring 421 of each of the massaging members 42 provides a cushioning effect to the user's feet, thereby providing a comfortable sensation to the user. Further, the foot massaging device is operated easily and conveniently, thereby facilitating the user operating the foot massaging device. Further, the foot massaging device has a simplified construction, thereby decreasing costs of fabrication thereof. Further, the foot massaging device is assembled easily and rapidly, thereby saving the manual work and working time.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A foot massaging device, comprising:
two shoe-shaped pedals;
a plurality of massaging members each retractably mounted on each of the two pedals.

2. The foot massaging device in accordance with claim 1, wherein each of the two pedals has an upper surface formed with a plurality of mounting holes to receive the massaging members.

3. The foot massaging device in accordance with claim 2, wherein each of the massaging members is selectively mounted in a respective one of the mounting holes of each of the two pedals.

4. The foot massaging device in accordance with claim 1, wherein each of the massaging members is selectively mounted on an upper surface of each of the two pedals.

5. The foot massaging device in accordance with claim 1, wherein each of the massaging members includes a housing mounted on each of the two pedals, a movable post movably mounted on the housing and having a first end protruded outward from the housing and formed with a massaging boss.

6. The foot massaging device in accordance with claim 5, wherein the massaging boss of each of the massaging members has a spherical shape.

7. The foot massaging device in accordance with claim 5, wherein the movable post of each of the massaging members has a second end received in the housing and formed with a resting flange rested on a top wall of the housing.

8. The foot massaging device in accordance with claim 7, wherein each of the massaging members further includes a spring mounted in the housing and pressed on the second end of the movable post.

9. The foot massaging device in accordance with claim 8, wherein the spring of each of the massaging members has a first end rested on a bottom wall of the housing and a second end rested on the resting flange of the movable post.
